(19) United States
(12) Patent Application Publication
(10) Pub. No.: US 2026/0249883 A1
(43) Pub. Date: Aug. 27, 2026

(54) CONTROL SYSTEM, CONTROL DEVICE, CONTROL METHOD, AND STORAGE MEDIUM THEREOF

(71) Applicant: DENSO CORPORATION, Kariya-city (JP)

(72) Inventor: Masatake ISHIKAWA, Kariya-city (JP)

(21) Appl. No.: 19/414,995

(22) Filed: Dec. 10, 2025

Related U.S. Application Data
(63) Continuation of application No. PCT/JP2024/018613, filed on May 21, 2024.

(30) Foreign Application Priority Data
Jun. 16, 2023 (JP) 2023-099403

(51) Int. Cl. B60W 60/00; B60K 16/00; G05D 1/243

(52) U.S. Cl. CPC B60W 60/0023; B60K 16/00; G05D 1/243; B60K 2016/003

(57) ABSTRACT

A control method is executed by a processor for controlling an autonomous traveling of an autonomous transport device. The autonomous transport device is supplied with power by a power generation unit. The power generation unit receives sunlight and generates, using the sunlight, electric power for storing a load, which requires refrigeration, in a transport chamber and transporting the load by performing the autonomous traveling. The control method includes: acquiring incident information indicating an incidence state of sunlight on the autonomous transport device, and adjusting a traveling posture of the autonomous transport device during the autonomous traveling to a control posture, which positions the transport chamber in a direction opposite to a sun direction with respect to a light receiving surface of the power generation unit. The light receiving surface is oriented toward the sun direction according to the incident information for receiving the sunlight.

### CROSS REFERENCE TO RELATED APPLICATIONS

The present application is a continuation application of International Patent Application No. PCT/JP2024/018613 filed on May 21, 2024, which designated the U.S. and claims the benefit of priority from Japanese Patent Application No. 2023-099403 filed on Jun. 16, 2023. The entire disclosures of all of the above applications are incorporated herein by reference.

### TECHNICAL FIELD

The present disclosure relates to a technology for controlling autonomous traveling of an autonomous transport device.

### BACKGROUND

There has been known a technology that searches for a travel route, which provides a large amount of sunlight irradiation to a vehicle equipped with a solar cell. The solar cell functions as a power generation unit and generates electric power using solar energy. There also has been known a technology that determines, based on a simulation result of sunlight incidence, a travel route for an autonomous transport device, which transports a load that requires refrigeration, such that a temperature of transport environment according to the determined travel route has a low temperature than other routes.

### SUMMARY

According to an aspect of the present disclosure, a control method is executed by a processor for controlling an autonomous traveling of an autonomous transport device. The autonomous transport device is supplied with power by a power generation unit. The power generation unit receives sunlight and generates, using the sunlight, electric power for storing a load, which requires refrigeration, in a transport chamber and transporting the load by performing the autonomous traveling. The control method includes acquiring incident information indicating an incidence state of sunlight on the autonomous transport device. The control method may further include adjusting a traveling posture of the autonomous transport device during the autonomous traveling to a control posture, which positions the transport chamber in a direction opposite to a sun direction with respect to a light receiving surface of the power generation unit. The light receiving surface is oriented toward the sun direction according to the incident information for receiving the sunlight.

### BRIEF DESCRIPTION OF DRAWINGS

The present disclosure will become apparent from the following detailed description made with reference to the accompanying drawings. In the drawings:

FIG. 1 is a block diagram showing a functional configuration of a control system according to a first embodiment;

FIG. 2 is a perspective view showing a physical configuration of an autonomous traveling device to which the first embodiment is applied;

FIG. 3 is a block diagram showing a functional configuration of the autonomous traveling device to which the first embodiment is applied;

FIG. 4 is a block diagram showing the functional configuration of the control system according to the first embodiment;

FIG. 5 is a flowchart showing a control flow according to the first embodiment;

FIG. 6 is a schematic diagram for explaining a control posture according to the first embodiment;

FIG. 7 is a schematic diagram for explaining a control posture according to the first embodiment;

FIG. 8 is a graph showing a cooling efficiency according to the first embodiment;

FIG. 9 is a graph showing a cooling efficiency according to the first embodiment;

FIG. 10 is a flowchart showing a control flow according to a second embodiment;

FIG. 11 is a flowchart showing a control flow according to a third embodiment;

FIG. 12 is a flowchart showing a control flow according to a third embodiment; and

FIG. 13 is a graph for explaining determination of an optimal route according to the third embodiment.

### DETAILED DESCRIPTION

As described above, a planned travel route, which provides a large amount of sunlight irradiation, is provided to a vehicle equipped with a solar cell. The solar cell generates corresponds to a power generation unit, and generates electric power using solar energy. When this technology is applied to an autonomous transport device equipped with a solar power generation unit and the autonomous transport device is controlled to transport a load that requires refrigeration, a temperature of the transport environment will rise since the travel route providing large amount of sunlight irradiation is selected. Thus, while the transport device transports the load by travelling the planned travel route, the temperature along the planned travel route will rise. On the other hand, when the technology that determines, based on a simulation result of sunlight incidence, a travel route for an autonomous transport device, which transports a load that requires refrigeration, such that a temperature of transport environment according to the determined travel route has a low temperature is applied to the autonomous transport device equipped with the solar power generation unit, the amount of received sunlight will decrease when the transport device transports the load by traveling the planned travel route.

The above-described difficulty arises from a trade-off between a power generation efficiency of power generation unit and a cooling efficiency for keeping the load cool. Thus, there is a need for breaking through the contradictory trade-off relationship from the perspective of energy saving.

According to a first aspect of the present disclosure, a control system includes at least one of (i) a circuit and (ii) a processor with a memory storing computer program code executable by the processor. The at least one of the circuit and the processor is configured to control an autonomous traveling of an autonomous transport device, which is supplied with power by a power generation unit. The power generation unit receives sunlight and generates, using the sunlight, electric power for storing a load, which requires refrigeration, in a transport chamber and transporting the load by performing the autonomous traveling. The at least one of the circuit and the processor is further configured to acquire incident information indicating an incidence state of sunlight on the autonomous transport device, and adjust a traveling posture of the autonomous transport device during the autonomous traveling to a control posture, which positions the transport chamber in a direction opposite to a sun direction with respect to a light receiving surface of the power generation unit. The light receiving surface is oriented toward the sun direction according to the incident information for receiving the sunlight.

According to a second aspect of the present disclosure, a control device is mountable to an autonomous transport device and control an autonomous traveling of the autonomous transport device. The autonomous transport device is supplied with power by a power generation unit. The power generation unit receives sunlight and generates, using the sunlight, electric power for storing a load, which requires refrigeration, in a transport chamber and transporting the load by performing the autonomous traveling. The control device includes at least one of (i) a circuit and (ii) a processor with a memory storing computer program code executable by the processor. The at least one of the circuit and the processor is configured to acquire incident information indicating an incidence state of sunlight on the autonomous transport device; and adjust a traveling posture of the autonomous transport device during the autonomous traveling to a control posture, which positions the transport chamber in a direction opposite to a sun direction with respect to a light receiving surface of the power generation unit. The light receiving surface is oriented toward the sun direction according to the incident information for receiving the sunlight.

According to a third aspect of the present disclosure, a control method executed by a processor for controlling an autonomous traveling of an autonomous transport device is provided. The autonomous transport device is supplied with power by a power generation unit. The power generation unit receives sunlight and generates, using the sunlight, electric power for storing a load, which requires refrigeration, in a transport chamber and transporting the load by performing the autonomous traveling. The control method includes: acquiring incident information indicating an incidence state of sunlight on the autonomous transport device; and adjusting a traveling posture of the autonomous transport device during the autonomous traveling to a control posture, which positions the transport chamber in a direction opposite to a sun direction with respect to a light receiving surface of the power generation unit. The light receiving surface is oriented toward the sun direction according to the incident information for receiving the sunlight.

According to a fourth aspect of the present disclosure, a non-transitory storage medium stores a control program including instructions to be executed by a processor to control an autonomous traveling of an autonomous transport device. The autonomous transport device is supplied with power by a power generation unit, which receives sunlight and generates, using the sunlight, electric power for storing a load, which requires refrigeration, in a transport chamber and transporting the load by performing the autonomous traveling. The instructions comprising: acquiring incident information indicating an incidence state of sunlight on the autonomous transport device; and adjusting a traveling posture of the autonomous transport device during the autonomous traveling to a control posture, which positions the transport chamber in a direction opposite to a sun direction with respect to a light receiving surface of the power generation unit. The light receiving surface is oriented toward the sun direction according to the incident information for receiving the sunlight.

According to the above-described first to fourth aspects, in order to transport the load that requires refrigeration in the transport chamber using autonomous traveling, the autonomous transport device, which is supplied with traveling power by the power generation unit, is controlled to perform the autonomous traveling. The power generation unit generates electric power using solar energy. In the first to fourth aspects, incident information about incidence of sunlight on the autonomous transport device is acquired, and the traveling posture of the autonomous transport device during autonomous traveling is adjusted in accordance with the incident information. The traveling posture of the autonomous transport device is adjusted to the control posture, which positions the transport chamber on the opposite side of the sun relative to the light receiving surface that is oriented toward the sun to effectively receive sunlight in accordance with the incident information of the power generation unit. By the above-described power generation unit, the light receiving surface is oriented toward the sun. Thus, power generation efficiency can be maintained. At the same time, in the transport chamber positioned on the opposite side of the sun relative to the light receiving surface, the cooling efficiency of load stored in the transport chamber can be ensured, thereby enabling energy saving.

The following will describe embodiments of the present disclosure with reference to the drawings. It should be noted that the same reference symbol is assigned to corresponding components in the respective embodiments, and repeated description may be omitted. When only a part of the configuration is described in each embodiment, the remaining configuration described in the foregoing embodiment may be applied to the remaining part of the configuration. Further, not only the combinations of the configurations explicitly shown in the description of the respective embodiments, but also the configurations of the multiple embodiments can be partially combined together even if the configurations are not explicitly shown if there is no contradiction in the combination in particular.

### First Embodiment

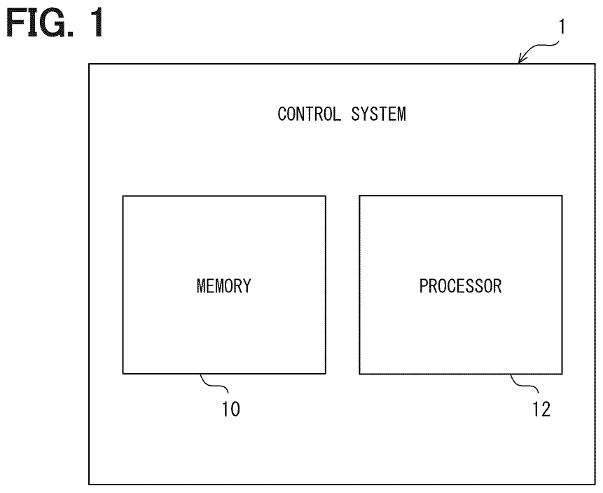

As shown in FIG. 1 to FIG. 3, a control system 1 of the first embodiment shown in FIG. 1 controls an autonomous traveling of an autonomous transport device Ma. The autonomous transport device Ma stores a load Gc in a transport chamber 20 and transports the load by performing an autonomous traveling. The autonomous transport device Ma is configured to move, by performing the autonomous traveling, in any direction on a flat surface, such as a horizontal plane.

The autonomous transport device Ma is intended to transport the load Gc that requires refrigeration. The load Gc needs to be kept cold. For example, the load Gc may be food, which is at least one of refrigerated product, frozen product, or room temperature product. The load Gc that needs to be kept cold may be at least one of the following items other than food, such as medicines, feed, solvents, solutions, miscellaneous items, building materials, and electronic devices. Such load Gc that require refrigeration may be stored into the transport chamber 20 in a state where the load is packed or wrapped in at least one of the following materials: cardboard boxes, polystyrene foam cases, plastic cases, or plastic films. The autonomous transport device Ma may transport a load Gc that do not require refrigeration, although it is configured to be able to transport the load Gc that requires refrigeration.

The autonomous transport device Ma may be a transport vehicle or a transport robot, which autonomously travels along a travel path (for example, a road) of an external route as a travel area, or autonomously travels along a travel path located inside or outside a building in a smart city as a travel area, to transport cargo as the load Gc. The autonomous transport device Ma may be a transport vehicle or a transport robot, which autonomously travels along a travel path inside or outside a warehouse in a logistics facility as a travel area, to transport cargo as the load Gc. The autonomous transport device Ma may be a food transport robot, which autonomously travels along a travel path within a restaurant or hospital as a travel area, to transport food and drink as the load Gc. The autonomous transport device Ma may be a disaster support robot, which autonomously travels while searching for a travelable route in a disaster area as a travel area, to transport supplies as the load Gc. The autonomous transport device Ma may be a device other than above-described examples. Any type of autonomous transport device Ma may be configured to receive remote travel support or travel control from an external center.

The autonomous transport device Ma includes a body 2, a drive system 3, a battery 4, a sensor system 5, a communication system 6, a map database 7, and an information presentation system 8. The body 2 may be made of metal and configured to have a hollow shape. The body 2 holds other components of the autonomous transport device Ma inside or across from the inside to the outside of body 2.

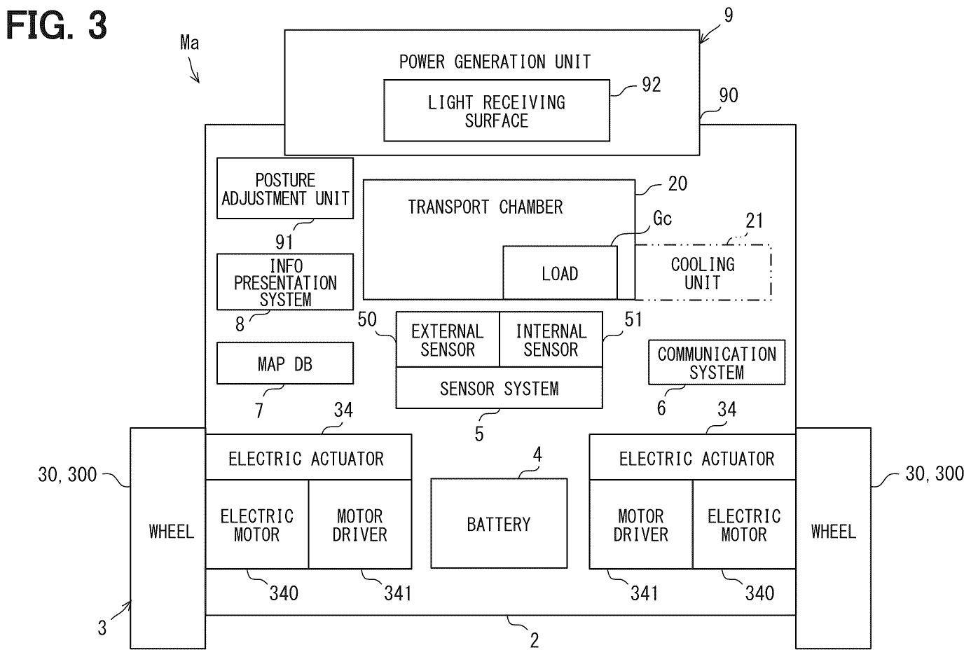

The body 2 has a transport chamber 20 for accommodating the load Gc, which corresponds to a transport target. The load Gc is loaded from outside into the transport chamber of the autonomous transport device Ma. The transport chamber 20 may have a box-shape and surrounded by walls made of heat insulating material to configure an internal space of refrigerated container, so as to be able to provide refrigeration performance for the load Gc. The transport chamber 20 is able to keep the load Gc at a temperature below a set temperature by using a cooling function of a cooling unit 21 (see two-dot chain line in FIG. 3) equipped to the body 2. The cooling unit 21 may be an air conditioning unit that adjusts an air conditioning temperature in the transport chamber 20, or may be a refrigeration unit that refrigerates (or freezes) the load Gc stored in the transport chamber 20.

The drive system 3 includes wheels 30 and an electric actuator 34. The wheels 30 are equipped to the body 2. Each of the wheels 30 is rotatable independently from one another. Among the multiple wheels 30, a pair of drive wheels 300 including one on a first side of the body 2 and the other one on a second side of the body 2, are independently driven by individual electric actuators 34, respectively. In the present embodiment, the traveling state of the autonomous transport device Ma is switched between a straight traveling and a turning traveling according to a difference in rotational speed between the two drive wheels 300 (that is, a difference in the number of rotations per unit time).

Specifically, when the difference in rotational speed between the left and right drive wheels 300 is zero or within a range that can be assumed to be zero, the autonomous transport device Ma travels in a straight line. When the difference in rotational speed between the left and right drive wheels 300 continues to increase, a turning radius of the autonomous transport device Ma decreases in accordance with the increase of difference in rotational speed between the left and right drive wheels. The turning radius means a distance in a plan view between the vertical center line of the body 2 and the center of turning movement of the body 2. The turning movement, which has the reduced turning radius of essentially zero is also referred to as point turning movement. The multiple wheels 30 may include at least one driven wheel that rotates following the drive wheel 300.

At least one battery 4 shown in FIG. 3 is equipped to the body 2. The battery 4 mainly includes a rechargeable battery, such as a lithium ion battery. The battery 4 stores a power output from the power generation unit 9 as power to be supplied to the electrical components of the body 2. The electrical components of the body consume the supplied electric power to perform operations. The battery 4 may be charged by external power source to store electric power to be supplied to the electrical components of the body 2. The electrical components of the body consume the supplied electric power to perform operations. The battery 4 may store electric power regenerated by the electric actuator 34. The battery 4 is connected to the electric actuator 34, the sensor system 5, the communication system 6, the map database 7, the information presentation system 8, and the power generation unit 9, via a wire harness so as to be able to supply power to these components. The battery 4 may also be connected to the cooling unit 21 when the cooling unit 21 is equipped to the body 2, via a wire harness so as to be able to supply power to the cooling unit 21.

A pair of electric actuators 34 are equipped to the body 2. The electric actuators 34 include a first electric actuator disposed on one side of the body 2 and a second electric actuator disposed on the other side of the body 2. Each electric actuator includes an electric motor 340 and a motor driver 341 as a set. In each electric actuator 34, the electric motor 340 rotates and drives the corresponding drive wheel 300 independently. In each electric actuator 34, the motor driver 341 adjusts a current applied to the corresponding electric motor 340 of the same set in accordance with a current command value from the control system 1, thereby controlling an output of driving torque to the corresponding drive wheel 300 in accordance with the current command value. Each electric actuator 34 may be provided with a brake unit that applies braking force to the corresponding drive wheel 300 while the drive wheel is rotating.

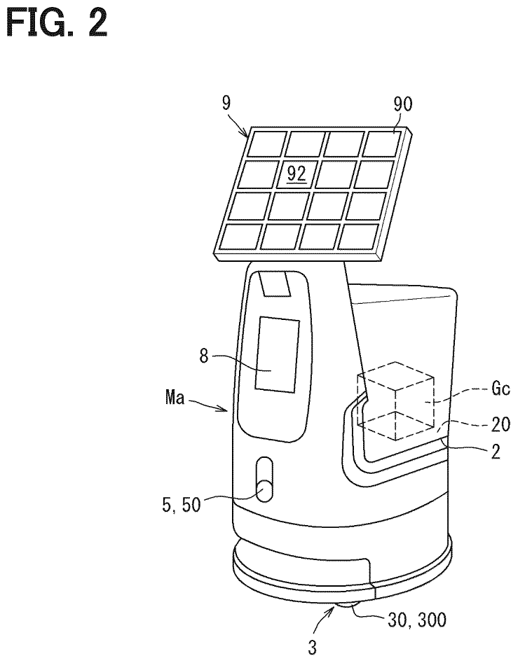

The sensor system 5 shown in FIG. 2 and FIG. 3 acquires sensing information, which can be used by the control system 1, by sensing an external and internal environment of the autonomous transport device Ma. For this purpose, components of the sensor system 5 are arranged at various locations on the body 2. Specifically, the sensor system 5 includes an external sensor 50 and an internal sensor 51.

The external sensor 50 acquires external information as sensing information from the external environment, which is the periphery environment of the autonomous transport device Ma. The external sensor 50 detects objects present in the external environment of the autonomous transport device Ma, thereby acquiring external environment information. The object detection type of external sensor 50 may be at least one of a camera, LiDAR (Light Detection and Ranging/Laser Imaging Detection and Ranging), radar, sonar, an ambient light sensor, and an impact sensor.

The internal sensor 51 shown in FIG. 3 acquires internal information as sensing information from the internal environment of the autonomous transport device Ma. The internal sensor 51 may be a physical quantity detection type that acquires internal information by detecting a specific physical quantity of motion in the internal environment of the autonomous transport device Ma. The physical quantity detection type of internal sensor 51 may be at least one of a travelling speed sensor, an acceleration sensor, or an inertial sensor. The internal sensor 51 may be an indoor detection type and acquires internal information by detecting an internal environment of the transport chamber 20, which is also the internal environment of the autonomous transport device Ma. The indoor detection type of internal sensor 51 may be at least one of a temperature sensor, a weight sensor, a pressure sensor, a camera, or an RFID (Radio Frequency Identifier) reader.

The communication system 6 transmits and receives communication information that can be used by the control system 1 via wireless communication between the autonomous transport device Ma and the external environment. The communication system 6 may be a positioning type that acquires communication information by receiving positioning signals from artificial satellites of the Global Navigation Satellite System (GNSS) that exist in the external environment of the autonomous transport device Ma. The communication system 6 of positioning type is, for example, a GNSS receiver or the like.

The communication system 6 may be a V2X type that transmits and receives communication information between the autonomous transport device Ma and a V2X system that exists in the external environment. The V2X type of communication system 6 may be at least one of a dedicated short range communications (DSRC) communication device or a cellular V2X (C-V2X) communication device. The communication system 6 may be a terminal communication type and transmits and receives communication information to and from a mobile terminal that exists in the external environment of the autonomous transport device Ma. The communication system 6 of terminal communication type may be at least one of Bluetooth (registered trademark) device, Wi-Fi (registered trademark) device, or infrared communication device.

The map database 7 stores map information usable by the control system 1. The map database 7 includes a non-transitory tangible storage medium, which is at least one type of a semiconductor memory, a magnetic medium, an optical medium, or the like. The map database 7 may be a database of a locator that estimates a self-position of the autonomous transport device Ma. The map database 7 may be a database of a planning unit that plans the travel of the autonomous transport device Ma. The map database 7 may be configured by combining multiple types of these databases.

The map database 7 acquires, through communication with an external center, and stores the latest map information. The map information is converted into two-dimensional or three-dimensional data as information representing the travel area of autonomous transport device Ma. As the three-dimensional map data, digital data of high definition map may be used. The map information may be acquired by downloading data, to the map database 7 via the communication system 6, from an infrastructure database included in an infrastructure system, such as an external center. The map information may be acquired by virtually dividing the travel area into multiple three-dimensional voxels (for example, three-dimensional grids) arranged in a three-dimensional array. The map information may be acquired by virtually dividing the travel area into multiple two-dimensional grids arranged in a two-dimensional tile. Then, each three-dimensional grid or two dimensional grids may be associated with an individual spatial ID.

The map information stored in the map database 7 may include road information that indicates at least one of the following: road position coordinates, road size, road shape, and road surface condition. The map information may include stationary object information that indicates at least one of the position coordinates, size, or shape of buildings, structures, or plants, which face the road. The map information may include road marking information that indicates at least one of the position coordinates, size, or shape of signs, boundary lines, or traffic lights attached to the road serving as the travel path.

The information presentation system 8 presents notification information to a person existing around the autonomous transport device Ma. The information presentation system 8 may present notification information by stimulating visual perception of a person existing around the autonomous transport device. The information presentation system 8 of visual stimulation type may be at least one type of a monitor unit, a light emitting unit, or the like. The information presentation system 8 may present notification information by stimulating auditory perception of a person existing around the autonomous transport device. The information presentation system 8 of auditory stimulation type may be at least one of a speaker, a buzzer, a vibration unit, or the like.

As shown in FIG. 2 and FIG. 3, the power generation unit 9 includes a solar panel 90. For example, the solar panel 90 may be a silicon-based, compound-based, organic-based, or quantum dot-based solar panel that can convert the solar energy into electric power and output the converted electric power. The solar panel 90 defines a light receiving surface 92 for receiving sunlight. The solar panel 90 generates electric power in response to receiving sunlight by the light receiving surface 92, and temporarily stores the electric power in the battery 4, and then outputs stored the electric power. As a result, the output power from the solar panel 90 is used at least to store the load Gc that requires refrigeration in the transport chamber 20 and transport the load by performing autonomous traveling.

In the present embodiment, the solar panel 90 is configured to move flexibly relative to the body 2. Specifically, among posture angles of the solar panel 90 in the autonomous transport device Ma, that is, among an azimuth angle in the horizontal plane and an elevation angle in the vertical plane, at least the elevation angle can be adjusted by a posture adjustment unit 91 included in the power generation unit 9.

The control system 1 shown in FIG. 1 controls the autonomous traveling of the autonomous transport device Ma along a planned route while recognizing the external environment and own position of the autonomous transport device. For this purpose, the control system 1 includes at least one dedicated computer, which includes a computer equipped to the body 2. The dedicated computer included in the control system 1 is connected to the electric actuator 34, the battery 4, the sensor system 5, the communication system 6, the map database 7, the information presentation system 8, and the power generation unit 9, via at least one of, for example, a LAN (Local Area Network) line, a wire harness, an internal bus, or a wireless communication line. The dedicated computer included in the control system 1 may be connected to the cooling unit 21 when the cooling unit 21 is equipped to the body 2, via at least one of a LAN line, a wire harness, or an internal bus.

The dedicated computer included in the control system 1 may be a planning ECU (Electronic Control Unit) that plans a future route as a travel plan of the autonomous transport device Ma. The dedicated computer included in the control system 1 may be an actuator ECU that controls the electric actuator 34 of the autonomous transport device Ma. The dedicated computer included in the control system 1 may be a power supply ECU that controls the battery 4 of the autonomous transport device Ma. The dedicated computer included in the control system 1 may be a sensing ECU that controls the sensor system 5 of the autonomous transport device Ma.

The dedicated computer included in the control system 1 may be a locator ECU that estimates the self-position of the autonomous transport device Ma based on the map database 7. The dedicated computer included in the control system 1 may be an information presentation ECU that controls the information presentation system 8 of the autonomous transport device Ma. The dedicated computer included in the control system 1 may be a power generation ECU that controls the power generation unit 9 of the autonomous transport device Ma. The dedicated computer included in the control system 1 may be a computer located outside the body 2, which constitutes, for example, an external center or a mobile terminal that can communicate with the autonomous transport device via the communication system 6.

The dedicated computer included in the control system 1 includes at least one memory 10 and at least one processor 12. The memory 10 is provided by a computer-readable non-transitory tangible storage medium, such as a semiconductor memory, a magnetic medium, or an optical medium, and stores computer-readable program and data. For example, the processor 12 may include, as a core, at least one of a central processing unit (CPU), a graphics processing unit (GPU), a reduced instruction set computer (RISC) CPU, a data flow processor (DFP), a graph streaming processor (GSP), or the like.

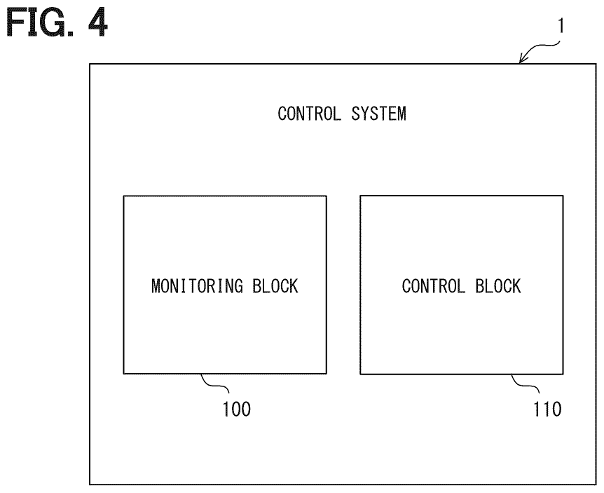

In the control system 1, the processor 12 executes instructions included in a control program stored in the memory 10 in order to control the autonomous traveling of the autonomous transport device Ma. As a result, the control system 1 constructs multiple function blocks for controlling the autonomous traveling of the autonomous transport device Ma. The multiple function blocks constructed by the control system 1 include a monitoring block 100 and a control block 110, as shown in FIG. 4.

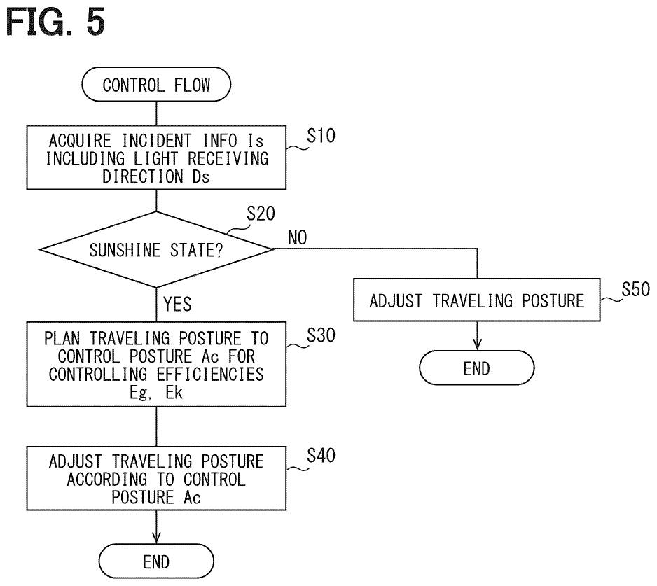

The control method performed by the control system 1 to control the autonomous traveling of the autonomous transport device Ma is executed by cooperation of the monitoring block 100 and the control block 110, according to the control flow shown in FIG. 5. The control flow of the first embodiment is repeatedly executed when the autonomous transport device Ma starts transport of the load Gc by autonomous traveling after start-up of the autonomous transport device, and the control flow is executed until the autonomous transport device Ma arrives at the destination of future route. Each “S” in the control flow indicates one or more processes executed by one or more instructions included in the control program.

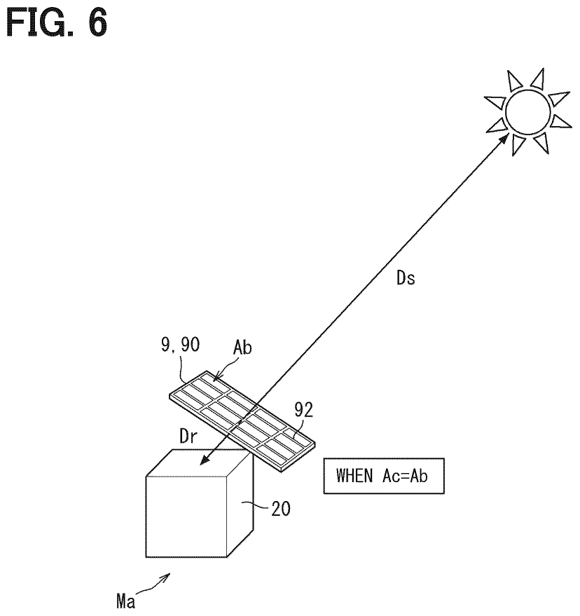

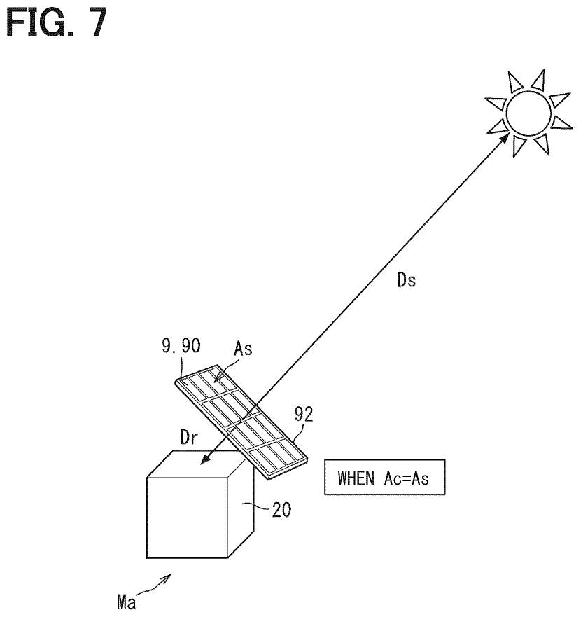

In S10, the monitoring block 100 acquires incident information Is indicating an incidence state of sunlight on the autonomous transport device Ma. The incident information Is includes a sun direction Ds (see FIG. 6 and FIG. 7), which is three-dimensional direction and indicates in which direction the sun exists when viewed from the autonomous transport device Ma. The sun direction Ds is defined by both the azimuth angle in the horizontal plane and the elevation angle in the vertical plane at a control target travel point. The control target travel points the latest control target among the travel points on the future route planned for the autonomous transport device Ma.

The incident information Is acquired in S10 may include, in addition to the sun direction Ds, at least one of the following: the altitude or position of the sun, the illuminance or amount of incident sunlight, weather information, and shade information on the future route. The incident information Is, which includes at least the sun direction Ds, may be obtained based on at least one of the necessary types, which include the ambient light sensor acquired as the sensing information by the external sensor 50, weather information acquired as the communication information by the communication system 6, positioning information acquired as the communication information by the communication system 6, map information acquired by the map database 7, or self-position information acquired by the locator ECU. For the control target travel point for which the environment condition is determined to be negative, that is S20: NO (described later), acquisition of the sun direction Ds as the incident information May be skipped.

In the control flow, S20 is executed after completion of S10. In S20, the monitoring block 100 determines whether the environment condition outside the autonomous transport device Ma is in a sunshine state where sunlight is incident on the autonomous transport device Ma. The determination of sunshine state in S20 is based on the incident information Is obtained in S10.

In response to a positive determination being made in S20 of the control flow, the process proceeds to S30. In S30, the control block 110 plans a traveling posture of the autonomous transport device Ma during the autonomous traveling. The traveling posture of the autonomous transport device Ma is planned to be an optimal control posture Ac for the control target travel point, which is the latest control target among the multiple travel points on the future route planned for the autonomous transport device Ma.

In S30, the control posture Ac is defined as a traveling posture in which the transport chamber 20 is positioned in the opposite direction Dr to the sun direction Ds, with respect to the light receiving surface 92 of the solar panel 90 of the power generation unit 9, as shown in FIG. 6 and FIG. 7. That is to say, the control posture Ac is defined as a traveling posture in which the transport chamber 20 is positioned on the opposite side to the sun with respect to the light receiving surface 92 of the solar panel 90, such that the transport chamber 20 is positioned in the shade generated by the light receiving surface 92. The light receiving surface 92 is oriented toward the sun direction Ds to receive sunlight. In the control posture Ac adjusted at the latest control travel point, at least a portion of the transport chamber 20 is controlled to be positioned in the shadow generated by the solar panel 90 in the opposite direction Dr to the sun direction, in accordance with the incident information Is obtained in S20. The shadow is generated by the light receiving surface 92, which is oriented toward the sun direction Ds.

In planning of the traveling posture in S30, the attitude angle of the autonomous transport device Ma on the travel path is controlled within the horizontal plane by each electric actuator 34. In this way, the light receiving surface 92 is oriented toward the sun direction Ds, while at the same time, the transport chamber 20 is positioned in the opposite direction Dr, thereby adjusting the control posture Ac. The orientation angle of the solar panel 90 of the autonomous transport device Ma can be controlled both in the horizontal plane and in the vertical plane. In the planning of the traveling posture, the orientation angle of the solar panel 90 of the autonomous transport device Ma is controlled by the posture adjustment unit 91 at least in the vertical plane. In this way, it is possible to adjust the orientation angle of the solar panel to the control posture Ac in which the light receiving surface 92 is directed toward the sun direction Ds, while the transport chamber 20 is positioned in the opposite direction Dr. In planning of the traveling posture, the posture angle of the autonomous transport device Ma on the travel path and the posture angle of the solar panel 90 of the autonomous transport device Ma may be adjusted.

In planning of the traveling posture in S30, the control posture Ac, which is also be referred to as a control target of the traveling posture, is set based on the correlation between the power generation efficiency Eg of the solar panel 90 of the power generation unit 9 and the cooling efficiency Ek of the load Gc in the transport chamber 20, so as to control the power generation efficiency Eg and the cooling efficiency Ek. Therefore, the control posture Ac is set as a control target that maximizes an energy efficiency Ee correlated with the efficiencies Eg and Ek according to the following mathematical formula 1 that adopts the weights ωg and ωk for the efficiencies Eg and Ek, respectively. In S30, at least one of the reference posture Ab shown in FIG. 6 or the inclined posture As shown in FIG. 7 is set as a candidate of the control posture Ac. In the reference posture Ab shown in FIG. 6, the light receiving surface 92 is perpendicular to the sun direction Ds. In the inclined posture As shown in FIG. 7, the light receiving surface 92 is inclined with respect to the sun direction Ds.

$$Ee = ω g \cdot Eg + ω k \cdot Ek \qquad ( Mathematical Formula 1 )$$

In S30, the power generation efficiency Eg is obtained as a power generation performance index by calculating the relative ratio of the power generated by the solar panel 90 in each of the positions Ab and As to the power generated in the reference position Ab. The power generation efficiency Eg at each posture Ab, As is obtained based on power generation related parameters including at least the sun direction Ds. The power generation related parameters may further include the altitude or position of the sun, the illuminance or incident amount of sunlight, shade information on the future route, the temperature of the solar panel 90, and the power generation performance of the power generation unit 9. Therefore, when obtaining the power generation efficiency Eg, the power generation related parameters may be determined based on at least one necessary type of information, such as the incident information Is obtained in S10 and the state detection information of the power generation unit 9.

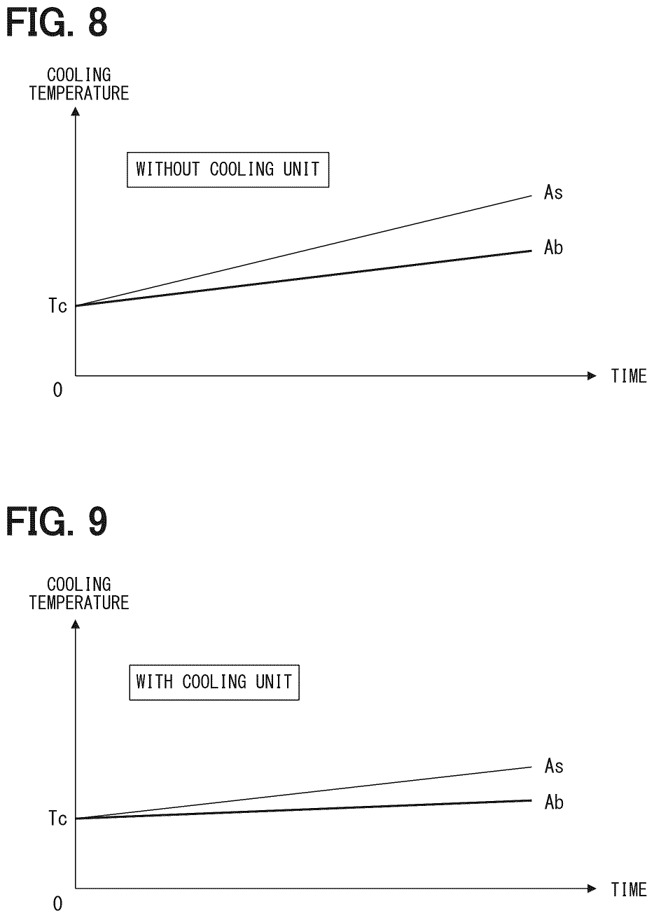

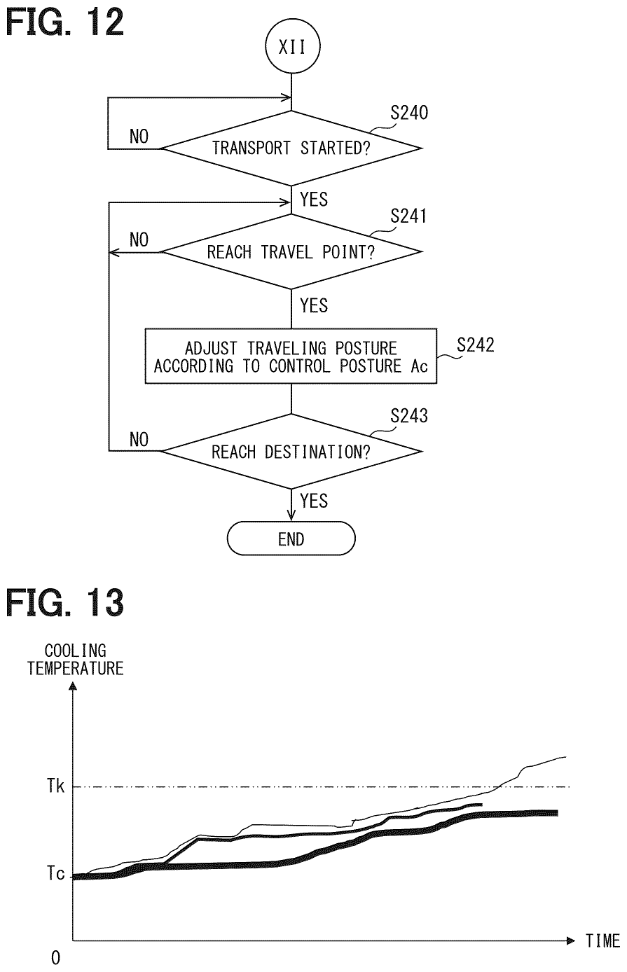

In S30, the cooling efficiency Ek is obtained as a cooling performance index. The cooling efficiency is calculated as a ratio of the temperature rise time under each posture to the temperature rise time under the reference posture Ab. The temperature rise time is defined as the rise time required of per unit temperature increase of the load Gc. As shown in FIG. 8 and FIG. 9, the cooling efficiency Ek may be obtained by predicting the temperature rise time in each posture Ab, As according to the cooling temperature Tc before the load Gc is loaded into the transport chamber 20. The cooling efficiency Ek may be obtained by predicting the temperature rise time in each posture Ab, As according to the cooling performance of the cooling unit 21, as shown in FIG. 9. When the cooling unit 21 is installed to the to the autonomous transport device, the cooling temperature of the load Gc that can be cooled during the autonomous traveling in the transport chamber 20 is shown in FIG. 9. In order to make it easier to understand the explanation regarding the temperature rise time, FIG. 8 and FIG. 9 schematically show the correlation between time and refrigeration temperature immediately after loading of the load Gc. In reality, when predicting the temperature rise time, it is better to take into account the change in refrigeration temperature over time according to the control posture Ac based on the previous control flow (see FIG. 12 related to the third embodiment to be described below).

In S30, the cooling efficiency Ek is acquired in each posture Ab, As based on, at least, the cooling related parameters including sun direction Ds or the opposite direction Dr. The cooling related parameters may include the sun direction Ds or the opposite direction Dr, information on the shade generated by the solar panel 90, the external environment temperature, the initial temperature of the load Gc at the time of loading, the initial temperature inside the transport chamber 20 at the time of loading, the cooling performance of the transport chamber 20, and shade information on the future route. Therefore, before obtaining the cooling efficiency Ek, the cooling related parameters should be acquired based on at least one necessary type, for example, the incident information Is obtained in S10, the temperature information of the temperature sensor provided as the internal sensor 51, or the cooling condition information of the load Gc before loading.

In S30, the energy efficiency Ee based on the efficiencies Eg and Ek is obtained for each posture Ab and As. The postures Ab and As are candidates for the control posture Ac. As described above, the weights ωg, ωk for respective efficiencies Eg, Ek in mathematical formula 1, which calculates the energy efficiency Ee, are set under a rule-based correlation using a simulation model, a function, a map, or a table.

In S30, in response to a predetermined condition being satisfied, such as the power stored in the battery 4 decreasing to a level equal to or below a threshold, the weight ωg of the power generation efficiency Eg may be adjusted to be greater than the weight ωk of the cooling efficiency Ek. In response to such predetermined condition being not satisfied, the opposite relationship may be set to the weights ωg, ωk. In S30, for example, in response to a predetermined condition being satisfied, such as time-based change rate of temperature in the transport chamber 20 decreases to a level equal to or below a threshold corresponding to a low ambient temperature (that is, the outside air temperature), the weight ωg of the power generation efficiency Eg may be adjusted to be greater than the weight ωk of the cooling efficiency Ek. In response to such predetermined condition being not satisfied, the opposite relationship may be set to the weights ωg, ωk.

In S30, in response to a predetermined condition being satisfied, such as the temperature in the transport chamber 20 increasing to a level equal to or higher than a threshold, the weight ωk of the cooling efficiency Ek may be adjusted to be greater than the weight ωg of the power generation efficiency Eg. In response to such predetermined condition being not satisfied, the opposite relationship may be set to the weights ωg, ωk. In S30, in response to a predetermined condition being satisfied, such as the temperature of the load Gc cooled before loading into the transport chamber increasing to a level equal to or higher than a threshold, the weight ωk of the cooling efficiency Ek may be adjusted to be greater than the weight ωg of the power generation efficiency Eg. In response to such predetermined condition being not satisfied, the opposite relationship may be set to the weights ωg, ωk.

As described above, in S30, the optimal posture that maximizes the energy efficiency Ee is selected as the control posture Ac, among the candidate postures Ab and As. In S30, under a condition that although the energy efficiency Ee is below the maximum efficiency but is as large as possible, the control posture Ac selected by S30 executed in a previous control flow or a control posture corresponding to the traveling environment at each travel point may be adopted as the optimal control posture Ac. The weights ωg, ωk of respective efficiencies Eg, Ek may be adjusted using a machine learning model to maximize the energy efficiency Ee, and a control posture Ac corresponding to the maximized energy efficiency Ee may be selected as the optimal control posture.

As shown in FIG. 5, in the control flow, S40 is executed following completion S30. In S40, the control block 110 adjusts the traveling posture of the autonomous transport device Ma at the latest control travel point in accordance with the control posture Ac selected in S30. For example, when there is concern that a temperature rise of the solar panel 90 may cause a significant decrease in the power generation efficiency Ek corresponding to the control posture Ac selected in S30, the travel speed of the autonomous transport device Ma may be increased to cooling the solar panel 90 using airflow generated by the wind. The current execution of control flow ends upon completion of S40.

In the control flow, when a negative determination is made in S20, the control flow proceeds to S50. In S50, the control block 110 adjusts the traveling posture of the autonomous transport device Ma at the latest control travel point. In S50, the traveling posture is controlled to the latest posture among the control postures Ac selected in S30 of previous control flow after the autonomous transport device Ma is started up. The traveling posture may be set to a default posture if S30 has never been executed in the previous control flow. The current execution of control flow ends upon completion of S50.

### (Effects)

The effects of the above-described first embodiment will be described below.

According to the first embodiment, in order to store the load Gc that requires refrigeration in the transport chamber 20 and transport them by autonomous traveling, control system controls the autonomous traveling of the autonomous transport device Ma. The autonomous transport device is supplied with power by the power generation unit 9. The power generation unit 9 generates electric power using solar power. Therefore, in the first embodiment, incident information Is indicating the incidence of sunlight on the autonomous transport device Ma is acquired. Then, the traveling posture of the autonomous transport device Ma during the autonomous traveling is adjusted in accordance with the incident information Is. The traveling posture of the autonomous transport device is adjusted to the control posture Ac that positions the transport chamber 20 in the opposite direction Dr to the sun direction Ds, with respect to the light receiving surface 92. The light receiving surface 92 of the power generation unit 9 is oriented in the sun direction Ds in accordance with the incident information Is for effectively receiving the sunlight. With this configuration, power generation efficiency Eg of the power generation unit 9 can be ensured by controlling the light receiving surface 92 to be oriented toward the sun direction Ds, while ensuring cooling efficiency Ek for the load Gc loaded in the transport chamber 20 by positioning the transport chamber 20 in the opposite direction to the sun direction Ds with respect to the light receiving surface 92. Thus, energy saving can be achieved with the above-described configuration.

According to the first embodiment, the posture angle of the autonomous transport device Ma on the travel path may be controlled so that the light receiving surface 92 of the power generation unit 9 faces the sun direction Ds of the sunlight. This configuration allows the light receiving surface 92 to be oriented toward the sun in the sun direction Ds to ensure power generation efficiency Eg, and the position of transport chamber 20 to be adjusted in the opposite direction Dr to the sun direction Ds relative to the light receiving surface 92 to ensure the cooling efficiency Ek. This arrangement of light receiving surface and the transport chamber can be accurately achieved by entirely controlling the posture angle of the autonomous transport device Ma. Therefore, it is possible to improve the reliability of energy saving.

According to the first embodiment, the posture angle of the power generation unit 9 in the autonomous transport device Ma may be controlled so that the light receiving surface 92 of the power generation unit 9 faces the sun direction Ds of the sunlight. This configuration allows the light receiving surface 92 to be oriented toward the sun in the sun direction Ds to ensure power generation efficiency Eg, and the position of transport chamber 20 to be adjusted in the opposite direction Dr to the sun direction Ds relative to the light receiving surface 92 to ensure the cooling efficiency Ek. This arrangement of light receiving surface and the transport chamber can be accurately achieved by individually controlling the posture angle of the power generation unit 9. Therefore, it is possible to improve the reliability of energy saving.

According to the first embodiment, the traveling posture of the autonomous transport device Ma may be adjusted to a control posture Ac that controls the cooling efficiency Ek of the load Gc cooled before it is loaded into the transport chamber 20. This configuration controls the cooling efficiency Ek of the transport chamber 20, which i positioned in the opposite direction Dr to the sun direction Ds with respect to the light receiving surface 92, to the optimal efficiency for the cooled load Gc, thereby achieving energy saving. Further, it is possible to promote energy saving by reducing the cooling temperature and/or cooling duration of the load Gc cooled before loading as much as possible and optimally controlling the cooling efficiency Ek in accordance with the reduction of cooling temperature and/or cooling duration.

According to the first embodiment, the traveling posture of the autonomous transport device Ma may be adjusted to a control posture Ac that controls the cooling efficiency Ek of the load Gc, which can be cooled in the transport chamber 20 during the autonomous traveling. This configuration controls the cooling efficiency Ek in the transport chamber 20, particularly in the direction Dr opposite to the sun direction Ds relative to the light receiving surface 92, to the optimal efficiency by utilizing the cooling function (specifically using the cooling unit 21), thereby achieving energy saving.

According to the first embodiment, the traveling posture of the autonomous transport device Ma is adjusted to the control posture Ac that maximizes the energy efficiency Ee, which correlates with the power generation efficiency Eg of the power generation unit 9 and the cooling efficiency Ek of the load Gc. This configuration allows the power generation efficiency Eg of the power generation unit 9 whose light receiving surface 92 faces the sun direction Ds and the cooling efficiency Ek of the transport chamber 20 located in the opposite direction Dr to the sun direction Ds relative to the light receiving surface 92 to be optimized by adjusting the control posture Ac from the perspective of maximizing the energy efficiency Ee. Therefore, it is possible to achieve energy saving according to the traveling environment of the autonomous transport device Ma.

### Second Embodiment

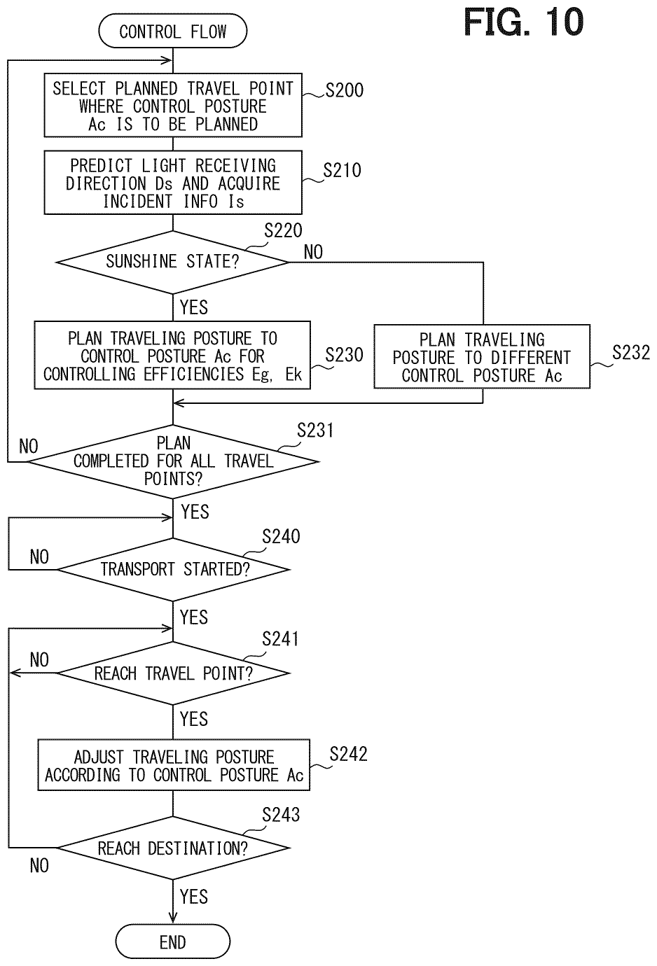

A second embodiment is a modification of the first embodiment. The control flow of the second embodiment shown in FIG. 10 is executed in response to the autonomous transport device Ma being started up.

In S200, the monitoring block 100 selects a planned travel point at which a control posture Ac is to be planned in advance among multiple travel points positioned at set distance intervals or set time intervals on the future route of the autonomous transport device Ma. Here, the planned travel point may be selected one by one each time S200 is executed, in order of furthest or nearest to the destination of the future route.

In the control flow, S210 is executed following completion of S200. In S210, the monitoring block 100 predicts the sun direction Ds of the sunlight incident on the solar panel 90 of the power generation unit 9 as the incident information Is corresponding to the latest planned travel point selected in S200. Similar to the sun direction Ds defined in S20 of the first embodiment, the incident information Is may be predicted based on at least one of the necessary types, which include the weather information acquired as the communication information by the communication system 6, positioning information acquired as the communication information by the communication system 6, map information acquired by the map database 7, or self-position information acquired by the locator ECU. However, for the planned travel point where the determination on the environment condition is negative in S220, which will be described later, prediction of the sun direction Ds may be skipped.

In the control flow, S220 is executed following completion of S210. In S220, the monitoring block 100 predicts whether the environment condition outside the autonomous transport device Ma is sunshine state where sunlight is incident on the autonomous transport device Ma, for the planned travel point selected in S200. The prediction of sunshine state is determined based on the incident information Is obtained in S210.

In response to a positive determination being made in S220, the control flow proceeds to S230. In S230, the control block 110 plans a control posture Ac, which is executed in S30 of the first embodiment, as the traveling posture of the autonomous transport device Ma during autonomous traveling for the latest planned travel point selected in S200. In S230, the traveling posture of the autonomous transport device Ma is planned for the latest planned travel point so that the control posture Ac controls the power generation efficiency Eg of the power generation unit 9 and the cooling efficiency Ek of the load Gc according to the predicted result of the sun direction Ds acquired in S210.

The control flow proceeds to S231 after completion of S230. In S231, the monitoring block 100 determines whether the planning of control posture Ac is complete by determining whether all travel points on the future route planned for the autonomous transport device Ma are set as the planned travel points. When a negative determination is made in S231, the control flow returns to S200, and the next planned travel point, for which the planning of control posture Ac has not been completed, is selected from the remaining travel points.

When a negative determination is made in S220, the control flow first proceeds to S232 and then proceeds to S231. In S232, the control block 110 plans the traveling posture of the autonomous transport device Ma during autonomous traveling for the planned travel point selected in S200 to a control posture Ac defined differently from the control posture determined in S230. The control posture Ac in S232 is defined as (i) among the control postures Ac selected by S230 already executed in the current control flow, the selected posture related to the planned travel point closest to the current position, or (ii) in a case where S230 has not been executed at all in the current control flow, the default posture. When S232 is executed, if a negative determination is made in S231, the control flow returns to S200.

Regardless of whether S232 is executed or not, that is, regardless of the prediction result of S220, in response to a positive determination being made in S231, the control flow proceeds to S240. In S240, the monitoring block 100 determines whether the autonomous transport device Ma has started transporting the load Gc by performing the autonomous travel. S240 is repeatedly executed if a negative determination is made.

When a positive determination is made in S240, the control flow proceeds to S241. In S241, the control block 110 determines whether the autonomous transport device has reached any one of the planned travel points where the control posture Ac has been planned in S230 or S232, that is, determines whether the autonomous transport device has arrived at the latest control travel point by performing the autonomous traveling. In response to a negative determination being made, S241 is repeated while the autonomous traveling control is maintained with the most recently adjusted control posture Ac.

In response to a positive determination being made in S241, the control flow proceeds to S242. In S242, the control block 110 adjusts the traveling posture of the autonomous transport device Ma similar to S40 of the first embodiment so that the traveling posture follows the control posture Ac at the planned travel point, which is the latest reached control travel point.

When a deviation between the optimal value in S230 and the observed value for the energy efficiency Ee for each travel point is greater than an acceptable threshold range, the control flow may execute, again, S200 to S241 in parallel with S242, and the control posture Ac for each travel point may be planned again. In this case, when a machine learning model is used to optimize the energy efficiency Ee in S230 similar to S30 of the first embodiment, the machine learning model may be updated based on the optimal value and the observed value. The predicted values of efficiencies Eg, Ek in S230 and the optimal value of the energy efficiency Ee based thereon may be obtained and compared for multiple autonomous transport devices Ma by a dedicated computer, which constitutes at least part of the control system 1. The dedicated computer may be disposed at an external center to select the autonomous transport device Ma that is optimal for the future route.

The control flow proceeds to S243 after completion of S242. in S243, the control block 110 determines whether the autonomous transport device has reached the destination of the future route, which is one of the control travel points, by performing the autonomous traveling. In response to a negative determination being made in S243, the control flow returns to S241. In response to a positive determination being made in S243 the current execution of the control flow ends.

According to the second embodiment described above, the sun direction Ds at each travel point on the future route of the autonomous transport device Ma is predicted as the incidence information Is. According to this configuration, the posture of the light receiving surface 92, which is adjusted according to the predicted result of the sun direction Ds in order to ensure power generation efficiency Eg, and the position of the transport chamber 20, which is adjusted to the opposite direction Dr from the predicted result of the sun direction Ds relative to the light receiving surface 92 in order to ensure the cooling efficiency Ek, can both be planned in advance for each travel point on the future route. Therefore, it is possible to achieve energy saving according to the traveling environment of the autonomous transport device Ma.

According to the second embodiment, the traveling posture of the autonomous transport device Ma is adjusted to the control posture Ac, which controls the power generation efficiency Eg of the power generation unit 9 and the cooling efficiency Ek of the load Gc, at each travel point on the future route of the autonomous transport device Ma in accordance with the predicted result of the sun direction Ds. According to this configuration, the posture of light receiving surface 92, which is adjusted according to the predicted result of the sun direction Ds in order to control the power generation efficiency Eg to the optimal efficiency, and the position of the transport chamber 20, which is adjusted to the opposite direction Dr to the predicted result of the sun direction Ds relative to the light receiving surface 92 in order to control the cooling efficiency Ek to the optimal efficiency, can both be planned in advance for each travel point on the future route. Therefore, it is possible to further improve liability of energy saving according to the traveling environment of the autonomous transport device Ma.

### Third Embodiment

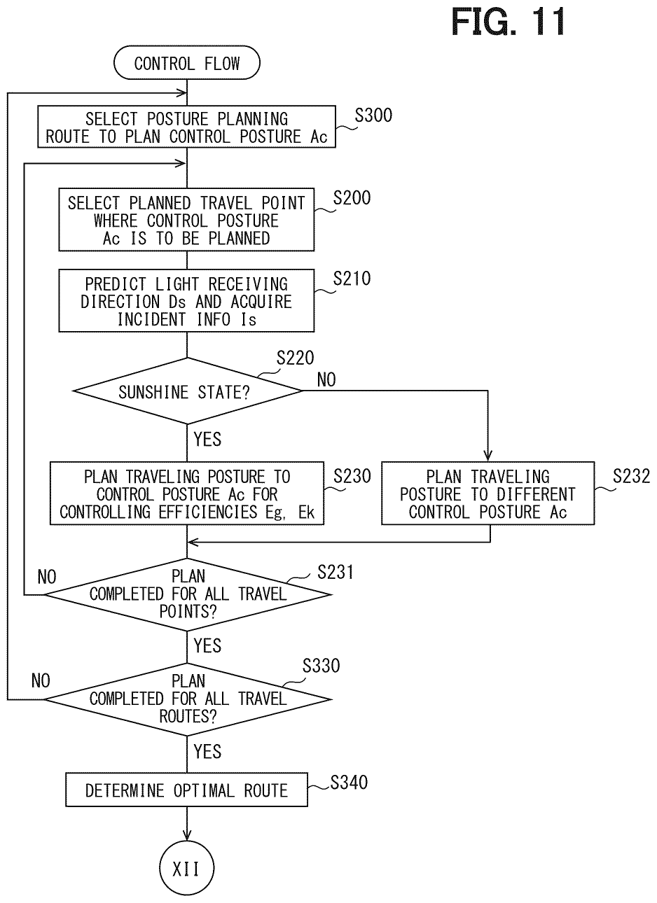

A third embodiment is a modification example of the second embodiment. The control flow of the third embodiment shown in FIG. 11 and FIG. 12 is executed in response to the autonomous transport device Ma being started up.

In S300 of FIG. 11, the monitoring block 100 selects a posture planning route, which plans the control posture A for each travel point, from multiple travel routes planned as future routes of the autonomous transport device Ma. In each execution of S300, one posture planning route is selected.

In the control flow, after execution of S300, S200 to S232 of the second embodiment are executed for the posture planning route selected in S300. In response to a positive determination being made in S231, the control flow proceeds to S330. In S330, the monitoring block 100 determines whether all future routes planned for the autonomous transport device Ma have been selected as posture planning routes such that the planning of control posture Ac at each travel point for all of the routes has been completed. In response to a negative determination being made in S330, the control flow returns to S300, and the next posture planning route is selected from the future routes for which planning of control posture Ac at each travel point has not been completed.

In response to a positive determination being made in S330, the control flow proceeds to S340. In S340, the control block 110 determines the optimal route in terms of energy efficiency Ee from all posture planning routes, which are the future routes where planning of control posture Ac for each travel point has been completed. The optimal route is determined based on, for example, the average value of the energy efficiency Ee corresponding to the control posture Ac at each travel point. As shown in FIG. 13, posture planning route in which the predicted refrigeration temperature of the load Gc before reaching the destination is equal to or higher than an allowable threshold temperature Tk may be excluded from the optimal route candidates. In FIG. 13, each of the lines with different thicknesses indicates the correlation between time and refrigeration temperature corresponding to each posture planning route.

In the control flow shown in FIG. 11 and FIG. 12, after execution of S340, S240 to S243 are executed for the optimal route selected in S340. In response to a positive determination being made in S243, the current execution of the control flow ends.

According to the above-described third embodiment, the future route (specifically, the optimal route), which adjusts the traveling posture to the control posture Ac at each travel point, is determined based on the power generation efficiency Eg of the power generation unit 9 and the cooling efficiency Ek of the load Gc for each travel point on each of the multiple planned future routes. This configuration allows the posture of the light receiving surface 92 to be aligned with the predicted result of the sun direction Ds, and the efficiencies Eg and Ek, which are used to adjust the position of the transport chamber 20 in the opposite direction Dr to the predicted result of the sun direction Ds, can also be effectively used in route determination. In the third embodiment, it is possible to improve energy saving by determining a route from the viewpoint of energy efficiency Ee, which correlates with each of the efficiencies Eg and Ek.

### Other Embodiments

While multiple embodiments are described above, the present disclosure is not interpreted as being limited to the embodiments and can be applied to various embodiments and combinations without departing from a spirit of the present disclosure.

The dedicated computer of the control system 1 of the modification example may include at least one of a digital circuit or an analog circuit, as a processor. The digital circuit is at least one type of, for example, an application specific integrated circuit (ASIC), a field programmable gate array (FPGA), a system on a chip (SOC), a programmable gate array (PGA), a complex programmable logic device (CPLD), and the like. Such digital circuits may also include a memory for storing program.

In the power generation unit 9 of the modification example, the solar panel 90 may be fixed at a position relative to the body 2. In S30 and S230 in the control flow of the modification example, the control posture Ac that controls only one of the efficiencies Eg and Ek may be selected.

In addition to the above-described embodiments and modifications, the present disclosure may be implemented in forms of a processing circuit (such as a processing ECU) or a semiconductor device (such as a semiconductor chip) as a control device mountable on the autonomous transport device Ma, and the control device may include at least one processor 12 and at least one memory 10.

What is claimed is:

1. A control system comprising
at least one of (i) a circuit and (ii) a processor with a memory storing computer program code executable by the processor,
wherein
the at least one of the circuit and the processor is configured to control an autonomous traveling of an autonomous transport device, which is supplied with power by a power generation unit,
the power generation unit receives sunlight and generates, using the sunlight, electric power for storing a load, which requires refrigeration, in a transport chamber and transporting the load by performing the autonomous traveling, and
the at least one of the circuit and the processor is further configured to:
acquire incident information indicating an incidence state of the sunlight on the autonomous transport device; and
adjust a traveling posture of the autonomous transport device during the autonomous traveling to a control posture, which positions the transport chamber in a direction opposite to a sun direction with respect to a light receiving surface of the power generation unit, the light receiving surface being oriented toward the sun direction according to the incident information for receiving the sunlight.

2. The control system according to claim 1, wherein the at least one of the circuit and the processor is further configured to
adjust the traveling posture such that the light receiving surface is oriented toward the sun direction by controlling a posture angle of the autonomous transport device traveling on a travel path.

3. The control system according to claim 1, wherein the at least one of the circuit and the processor is further configured to
adjust the traveling posture such that the light receiving surface is oriented toward the sun direction by controlling a posture angle of the power generation unit.

4. The control system according to claim 1, wherein the at least one of the circuit and the processor is further configured to
adjust the traveling posture to the control posture, which is a posture for controlling a cooling efficiency of the load that has been cooled before being loaded into the transport chamber.

5. The control system according to claim 1, wherein the at least one of the circuit and the processor is further configured to
adjust the traveling posture to the control posture, which is a posture for controlling a cooling efficiency of the load that can be cooled during the autonomous traveling of the autonomous transport device.

6. The control system according to claim 1, wherein the at least one of the circuit and the processor is further configured to
adjust the traveling posture to the control posture, which maximizes an energy efficiency correlated with a power generation efficiency of the power generation unit and a cooling efficiency of the load.

7. The control system according to claim 1, wherein the at least one of the circuit and the processor is further configured to
acquire the incident information by predicting, as the incident information, the sun direction at each travel point on a future route of the autonomous transport device.

8. The control system according to claim 7, wherein the at least one of the circuit and the processor is further configured to
adjust the traveling posture to the control posture, which is a posture for controlling a power generation efficiency of the power generation unit and a cooling efficiency of the load at each travel point in accordance with the predicted sun direction at the corresponding travel point.

9. The control system according to claim 7, wherein the at least one of the circuit and the processor is further configured to
determine multiple planned future routes and adjust, for each of the multiple planned future routes, the traveling posture to the control posture at each travel point based on a power generation efficiency of the power generation unit and a cooling efficiency of the load.

10. A control device mountable to an autonomous transport device and controlling an autonomous traveling of the autonomous transport device, the autonomous transport device being supplied with power by a power generation unit, the power generation unit receiving sunlight and generating, using the sunlight, electric power for storing a load, which requires refrigeration, in a transport chamber and transporting the load by performing the autonomous traveling,
the control device comprising at least one of (i) a circuit and (ii) a processor with a memory storing computer program code executable by the processor, wherein
the at least one of the circuit and the processor is configured to:
acquire incident information indicating an incidence state of sunlight on the autonomous transport device; and
adjust a traveling posture of the autonomous transport device during the autonomous traveling to a control posture, which positions the transport chamber in a direction opposite to a sun direction with respect to a light receiving surface of the power generation unit, the light receiving surface being oriented toward the sun direction according to the incident information for receiving the sunlight.

11. A control method executed by a processor for controlling an autonomous traveling of an autonomous transport device, the autonomous transport device being supplied with power by a power generation unit, the power generation unit receiving sunlight and generating, using the sunlight, electric power for storing a load, which requires refrigeration, in a transport chamber and transporting the load by performing the autonomous traveling,
the control method comprising:
acquiring incident information indicating an incidence state of sunlight on the autonomous transport device; and
adjusting a traveling posture of the autonomous transport device during the autonomous traveling to a control posture, which positions the transport chamber in a direction opposite to a sun direction with respect to a light receiving surface of the power generation unit, the light receiving surface being oriented toward the sun direction according to the incident information for receiving the sunlight.

12. A non-transitory storage medium storing a control program including instructions to be executed by a processor to control an autonomous traveling of an autonomous transport device, the autonomous transport device being supplied with power by a power generation unit, the power generation unit receiving sunlight and generating, using the sunlight, electric power for storing a load, which requires refrigeration, in a transport chamber and transporting the load by performing the autonomous traveling,
the instructions comprising:
acquiring incident information indicating an incidence state of sunlight on the autonomous transport device; and
adjusting a traveling posture of the autonomous transport device during the autonomous traveling to a control posture, which positions the transport chamber in a direction opposite to a sun direction with respect to a light receiving surface of the power generation unit, the light receiving surface being oriented toward the sun direction according to the incident information for receiving the sunlight.
